(19) United States
(12) Patent Application Publication
(10) Pub. No.: US 2011/0208714 A1
(43) Pub. Date: Aug. 25, 2011

(54) LARGE SCALE SEARCH BOT DETECTION

(75) Inventors: David Soukal, Bothell, WA (US); Fang Yu, Sunnyvale, CA (US); Yinglian Xie, Cupertino, CA (US); Qifa Ke, Cupertino, CA (US); Zijian Zheng, Bellevue, WA (US); Frederic H. Behr, JR., Kirkland, WA (US)

(73) Assignee: c/o Microsoft Corporation, Redmond, WA (US)

(21) Appl. No.: 12/708,541

(22) Filed: Feb. 19, 2010

(51) Int. Cl. G06F 17/30; G06F 21/00

(52) U.S. Cl. 707/709; 726/23; 707/710; 707/E17.108

(57) ABSTRACT

A framework may be used for identifying low-rate search bot traffic within query logs by capturing groups of distributed, coordinated search bots. Search log data may be input to a history-based anomaly detection engine to determine if query-click pairs associated with a query are suspicious in view of historical query-click pairs for the query. Users associated with suspicious query-click pairs may be input to a matrix-based bot detection engine to determine correlations between queries submitted by the users. Those users indicating strong correlations may be categorized as bots, whereas those who do not may be categorized as part of flash crowd traffic.

### BACKGROUND

Web search has become a powerful and indispensable means for people to obtain information today. Attackers are exploiting search as a channel for information collection and malicious attacks. For example, there have been botnet attacks that search and click advertisements displayed with query results to deplete competitors' advertisement budgets. The term botnet refers to a group of compromised host computers (bots) that are controlled by a small number of commander hosts generally referred to as Command and Control (C&C) servers.

Botnets have been widely used for sending queries to either inflate or deflate query click-through rates, and hence may have negative impact on search result rankings. Malicious botnet attackers have also used search engines to find web sites with vulnerabilities, to harvest email addresses for spamming, or to search well-known blacklists. By programming a large number of distributed bots, where each bot submits only a few queries to web search engines, spammers can effectively transmit thousands of queries in a short duration. To date, detecting individual bots is difficult due to the transient nature of the attack and because each bot may submit a few queries. Furthermore, despite the increasing awareness of botnet infections and associated control processes, there is little understanding of the aggregated behavior of botnets from the perspective of search engines that have been targets of large scale botnet attacks.

### SUMMARY

A framework may be used for identifying low-rate search bot traffic using query logs by capturing groups of distributed, coordinated search bots. Search log data may be input to a history-based anomaly detection engine to determine if query-click pairs associated with a query are suspicious in view of historical query-click pairs for the query. Users associated with suspicious query-click pairs may be input to a matrix-based bot detection engine to determine correlations between queries submitted by the users. Those users indicating strong correlations may be categorized as bots, whereas those who do not may be categorized as part of flash crowd traffic.

In some implementations, there is provided a method for identifying bots that may include sampling a search log maintained by a search engine to extract features of searches conducted by users that have submitted queries to the search engine. History-based anomaly detection may be performed by comparing click patterns associated with a query in the search log to historical click patterns associated with the query. A matrix-based bot detection may be performed using a matrix composed of a group of users that each submitted the query within a set of queries. The matrix-based bot detection may classify users within the group as bots based on a correlation of queries within the set of queries submitted by the users to the search engine.

In some implementations, there is provided a method for identifying suspicious search-related traffic that includes performing a history-based anomaly detection by comparing a histogram of links returned by a query versus a percentage of clicks associated with each link to a historical histogram of links returned by the query versus the historical percentage of clicks associated with each link to determine suspicious query-click pairs within a search log. A matrix may be created of a group of users that submitted the suspicious query-click pairs in accordance with a feature of the group of the users. Matrix-based bot detection may be performed using the matrix to classify users within the group of users as bots. The classification may be based on a correlation of queries within the suspicious query-click pairs submitted by the users to the search engine.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views:

FIG. 1 illustrates an exemplary environment;

FIG. 2 illustrates an example framework for identifying bot-generated search traffic from query logs;

FIGS. 3 and 4 illustrate histograms associated with a query q;

FIG. 5 illustrates a distribution across groups that are detected by a history-based scheme;

FIGS. 6A and 6B illustrate an exemplary process for bot detection; and

FIG. 7 shows an exemplary computing environment.

### DETAILED DESCRIPTION

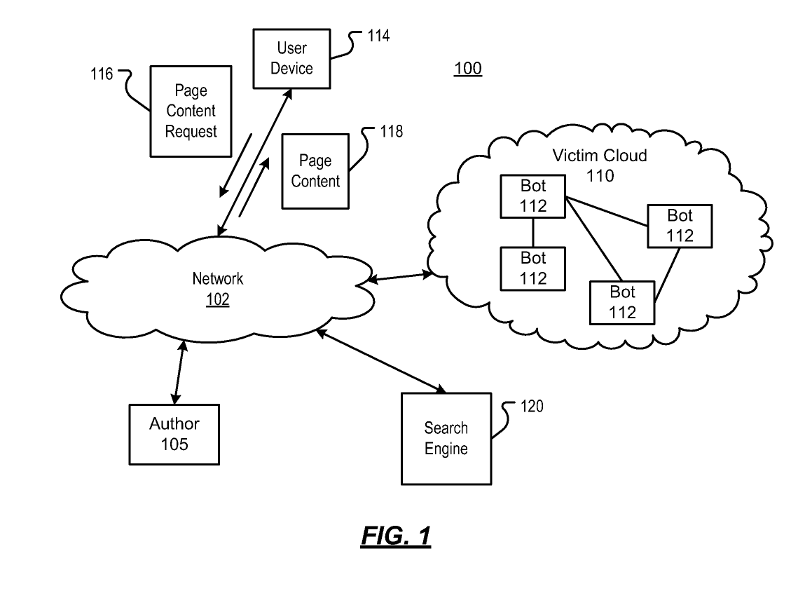

FIG. 1 illustrates an exemplary environment 100 including botnets that may be utilized in an attack on a web search server. FIG. 1 illustrates a computer network 102, a malware author 105, a victim cloud 110 of bot computers 112, a user device 114, and a search engine 120.

The computer network 102, such as a local area network (LAN), wide area network (WAN), the Internet, or a combination thereof, connects the malware author 105 and the victim cloud 110 of bot computers 112 to each other. In addition, the user device 114 and the search engine 120 may connect through the computer network 102. Although not shown, the environment 100 may include many thousands of user devices 114, bot computers 112 and other connected devices.

Upon infection, each bot computer 112 may contact other bots, online forums, a command and control computer, or other location(s)/device(s) to obtain instructions. The instructions obtained by each bot computer 112 direct the actions of the bot computer 112 as it participates in an attack or other activity.

The search engine 120 may receive queries for search results. In response, the search engine 120 may retrieve relevant search results from an index of documents (e.g., from an index of web pages). Search results may include, for example, lists of web page titles, snippets of text extracted from those web pages, and hypertext links to those web pages, and may be grouped into a predetermined number of (e.g., ten, twenty, etc.) search results. The search engine 120 may combine the search results with one or more of the advertisements.

A user device, such as the user device 114, may submit a page content request 116 (a query) to the search engine 120. In some implementations, page content 118 (a results page) may be provided to the user device 114 in response to the request 116. The page content may include advertisements provided by the advertisement management system 104. Example user devices 114 include personal computers (PCs), mobile communication devices, television set-top boxes, etc. The bot computers 112 may also submit a page content request 116 to the search engine 120. The submissions of the bot computers 112 to the search engine 120 may be made to influence search results provided by the search engine 120 in the page content 118, deplete an advertising budget of, e.g., a competitor through clicks of advertising on the page content 118, etc.

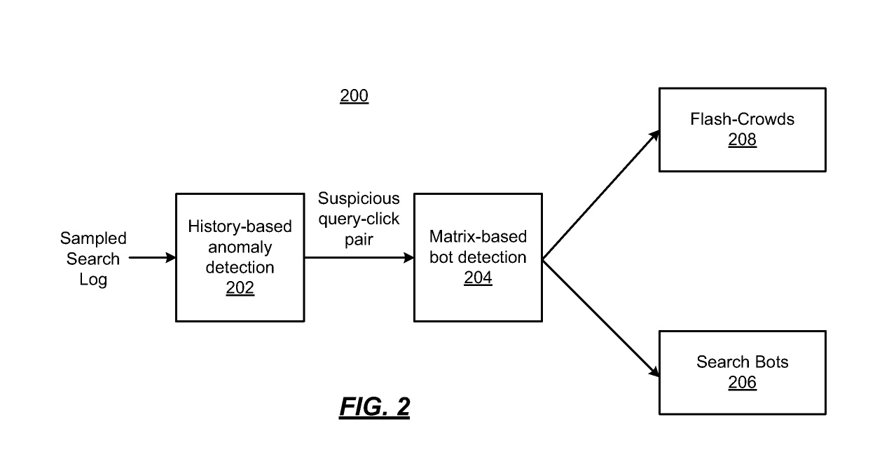

FIG. 2 is a block diagram of an example framework 200 for identifying bot-generated search traffic from query logs. The framework 200 leverages a characteristic that many bot-generated queries are controlled by a common master host and issued in a coordinated way. Therefore, while individual bot-generated queries may look indistinguishable from normal user issued queries, they often show common or similar patterns when viewed in the aggregate.

In some implementations, the framework 200 identifies groups of users and examines the aggregated properties of their search activities. By focusing on groups, the framework 200 is robust to noise introduced by sophisticated attackers. As bots follow scripts issued by the commander, bot-generated activities are similar in nature. The framework 200 leverages this property and aims to identify groups with similar search activities. In addition, search bots from different geo-regions display different characteristics. For example, search bots from countries with high speed Internet access (e.g., Japan, Singapore, United States, etc.) are more aggressive in submitting queries than those from other locations.

In some implementations, search logs are input to a history-based anomaly detection engine 202 of the framework 200. Search logs of the search engine 120 may be sampled based on features of the users submitting queries. The features may be, but are not limited to: a client ID, query, clicks, hash of cookie, cookie data, Internet Protocol (IP) address, hash of user agent, form code, and whether JavaScript is enabled on the client. The history-based anomaly detection engine 202 identifies suspicious search activity groups that deviate from historical activities. For example, these groups may include the search bots (e.g., bot computers 112) and flash crowd events (e.g., an unexpected surge in visitors to a web site).

The history-based anomaly detection engine 202 analyzes differences between the motivations of search bots as compared to human users. For example, the search bots may excessively click a link to promote the page rank, or click a competitor's advertisements to deplete their advertisement budget. In these cases, the search bots are attempting to influence the search engine to change the search results. As a result, query-click patterns of search bots are different from normal users. Also, the attack with the click traffic is usually short-lived, as attackers utilize many compromised bot computers 112 to perform distributed attacks. Therefore, in some implementations, a history-based detection approach may be used to analyze a change of query-click patterns to capture the new attacks.

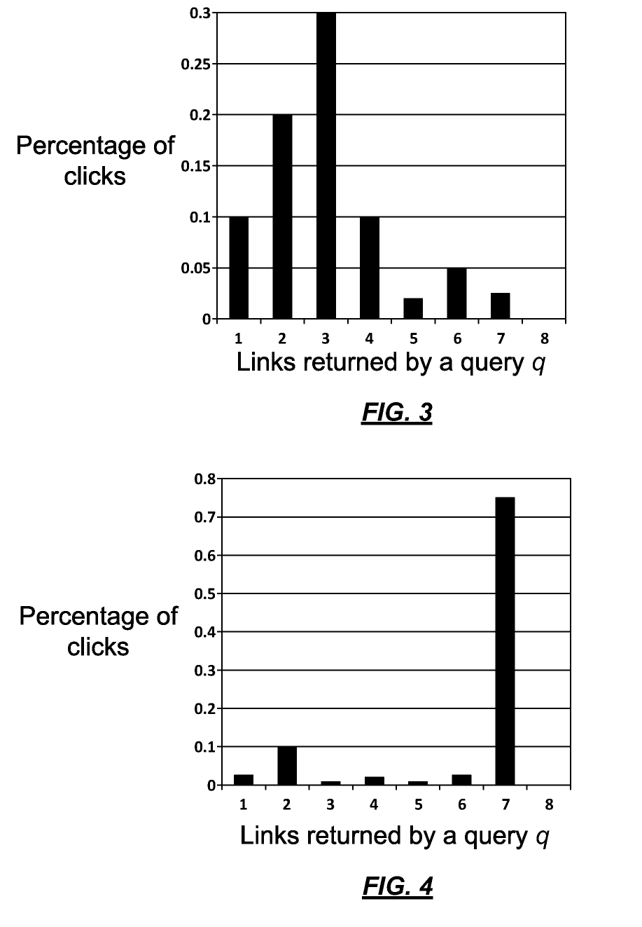

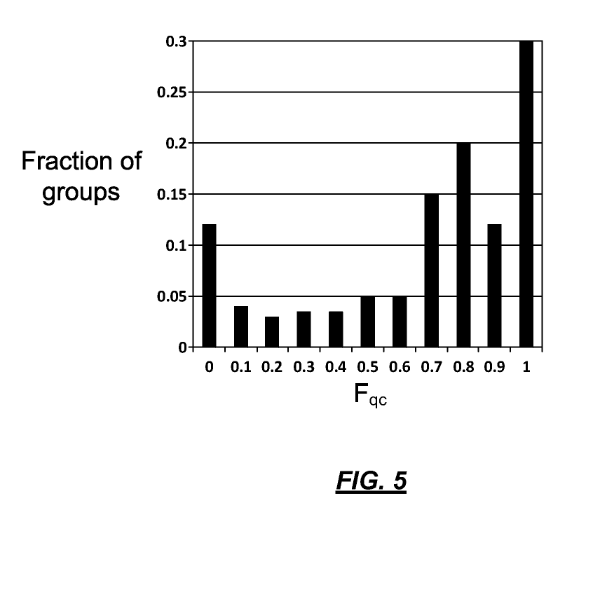

Each query q that is submitted to the search engine through a page content request 116 retrieves a query result page as page content 118. On the page content 118, there may be many links {L₁, L₂, . . . , Lₙ}. A user can click zero or more of such links. No click may be treated as a special type of click. Given the click statistics, a histogram of click distributions of query q may be built, as illustrated in FIGS. 3 and 4. Each bar in the histograms corresponds to one link Lᵢ and the bar value is the corresponding percentage of clicks. The histogram of query-click distribution may change over time. For example, FIG. 3 illustrates a historical histogram of query q, whereas FIG. 4 may illustrate a current histogram associated with the query q.

In some implementations, a smoothed Kullback-Leibler divergence may be used to compare the histogram of current query-click activities against historical values. To do so, Hₛ(i), i={L₁, . . . , Lₙ}, may denote the historical histogram of clicks on Lᵢ, and H_{c}(i) the current histogram of clicks. The histogram H(i) may be normalized such that ΣᵢH(i)=1. The Kullback-Leibler divergence from current histogram H_{c} to the historical histogram Hₛ is defined as:

$${D}_{KL} ( {H}_{C} \vert \vert {H}_{S} ) = {\sum }_{i} {H}_{C} ( i ) log \frac{{H}_{C} ( i )}{{H}_{S} ( i )} \qquad ( 1 )$$

The Kullback-Leibler divergence is always non-negative, i.e., D_{KL} (H_{c}∥Hₛ)≧0, with D_{KL}(H_{c}∥Hₛ)=0 if and only if H_{c}=Hₛ.

The value, D_{KL}, measures the difference between two normalized histograms. For each link Lᵢ associated with a given query, the ratio

$$\frac{{H}_{C} ( i )}{{H}_{S} ( i )}$$

measures the frequency change of clicks on the link Lᵢ. The log of this ratio is then weighted by a current click frequency H_{c}(i), and the Kullback-Leibler distance in equation (1) is the sum of the weighted log ratios over all clicked links i={L₁, . . . , Lₙ}.

In some implementations, equation (1) may be modified to detect search bots that are currently active. In other words, the framework 200 may be interested in links that receive more clicks. To account for this, the log ratio may be replaced by:

$$max \{ log \frac{{H}_{C} ( i )}{{H}_{S} ( i )} , 0 \}$$

Alternatively or additionally, if the current click histogram is similar to the historical histogram, but the total number of clicks associated with a query is increased, the framework 200 may mark such query-clicks as suspicious for further examination using a matrix-based method (by, e.g., the matrix-based bot detection engine 204). This may be performed for query terms that are associated with only one type of click where the normalized histogram would be the same for these queries. As such, a second term, log

$$\frac{{N}_{C}}{{N}_{S} + 1}$$

may be added, where N_{c} is a total number of clicks currently received for a given query, and Nₛ is a total number of clicks associated with the same query in the history.

As such, a modified Kullback-Leibler distance may be:

$${D}_{KLm} ( {H}_{C} \vert \vert {H}_{S} ) = log \frac{{N}_{C}}{{N}_{S} + 1} {\sum }_{i} {H}_{C} ( i ) max \{ log \frac{{H}_{C} ( i )}{{H}_{S} ( i )} , 0 \} \qquad ( 2 )$$

A smoothing version of Hₛ(i) may be used to avoid overflow in D_{KLm}, by replacing zero values in Hₛ(i) with a small value ε. For example,

$${H}_{S} ( i ) = \{ \begin{matrix}β {H}_{S} ( i ) , & if {H}_{S} ( i ) > 0 \\ ɛ , & otherwise\end{matrix}$$

where β is a normalization factor such that the resulted histogram satisfies ΣᵢH(i)=1.

If there is significant difference (i.e., D_{KLm} (Hc∥Hs)>α) between the historical histogram and current one, it may be concluded that the query q is a suspicious query (e.g., α may be set equal to 1 or another value depending on the implementation). For a link that is more popular than history, it may be selected as a suspicious click c, and a query-click pair <q,c> formed (abbreviated to “QC pair” herein, where qc denotes a particular “QC pair” value). If multiple links are becoming popular, multiple QC pairs may be generated.

The history-based detection within the history-based anomaly detection engine 202 captures events that suddenly get popular and outputs suspicious query-click pairs to a matrix-based bot detection engine 204. The matrix-based bot detection engine 204 implements a matrix-based approach to distinguish the search bots 206 from flash crowds 208, as will be described below. These events can include both bot events and flash crowd events. In particular, a difference between the bot traffic and flash crowds is that bot traffic is typically generated by a script. In contrast, flash crowd activities are originated from human users. Therefore, the flash crowd groups exhibit a higher degree of diversity. In other words, although the users who generate the flash crowd traffic share the same interest at one time, e.g., search Michael Jackson and click his webpage, they may have a different search history and also diverse system configuration, such as different browsers and/or operating systems.

In some implementations, the query history may be used as a feature to drive the matrix-based approach. Other features, such as system configurations may be used for validation. The matrix-based approach leverages the diversity of users to distinguish bot events from flash crowds. For each suspicious QC pair qc detected by the history-based technique, all users U_{qc}={U₁,U₂, . . . , Uₘ} are selected who performed this query-click activity. Next, the search traffic from U_{qc} is extracted into a group G. The group G may be constructed such that users U_{qc} have one or more similar features in common. The features may be, but are not limited to: a client identifier (ID), query, clicks, hash of cookie, cookie data, Internet Protocol (IP) address, hash of user agent, form code, and/or whether JavaScript is enabled on the client. If there are n unique queries {Q₁,Q₂, . . . , Qₙ} in the group, a matrix M_{qc} may be constructed as shown below in Matrix 1. Each row in the matrix corresponds to a query and each column represents a user. M_{qc(i,j)} denotes the number of query Qᵢ originated from user Uⱼ.

$$\begin{matrix}{Q}_{1} & 0 & 0 & 0 & … & 0 \\ {Q}_{2} & 1 & 0 & 0 & … & 0 \\ {Q}_{3} & 0 & 0 & 1 & … & 1 \\ {Q}_{4} & 2 & 5 & 0 & … & 1 \\ & … & … & … & … & … \\ {Q}_{N} & 4 & 5 & 1 & … & 1 \\ & {U}_{1} & {U}_{2} & {U}_{3} & … & {U}_{N}\end{matrix} \qquad Matrix 1$$

Matrix 2 represents a flash crowd matrix, where users share one identical query (e.g., in the last row), but their other queries are diverse and uncorrelated. Matrix 3 represents a bot matrix, where many users in the matrix have identical/correlated behavior (e.g., columns 1, 2, 4 and 5).

$$\begin{matrix}\begin{matrix}0 & 0 & 1 & 0 & 0 & 0 \\ 0 & 0 & 0 & 0 & 1 & 0 \\ 1 & 0 & 0 & 0 & 4 & 0 \\ 2 & 5 & 0 & 0 & 1 & 0 \\ 0 & 0 & 0 & 0 & 0 & 8 \\ 2 & 2 & 4 & 0 & 0 & 1 \\ 4 & 5 & 1 & 1 & 1 & 1\end{matrix} & Matrix 2 \\ \begin{matrix}1 & 1 & 0 & 1 & 1 & 1 \\ 0 & 0 & 1 & 0 & 0 & 0 \\ 0 & 0 & 5 & 0 & 0 & 0 \\ 1 & 1 & 2 & 1 & 1 & 3 \\ 3 & 3 & 6 & 3 & 3 & 4\end{matrix} & Matrix 3\end{matrix}$$

In some cases, bot activities are very dedicated, with each bot user only issuing one or a few queries. For these cases, a metric F_{qc} may be used to quantify the “focusness” of the group, i.e., a percentage of traffic originating from users that searched only for q over the total traffic in G.

$${F}_{qc} = \frac{\{ {\sum }_{j} {M}_{qc} ( q , j ) \vert ∀ j , s . t . {\sum }_{i \neq q} {M}_{qc} ( i , j ) = 0 \}}{{\sum }_{ij} {M}_{qc} ( i , j )} \qquad ( 3 )$$

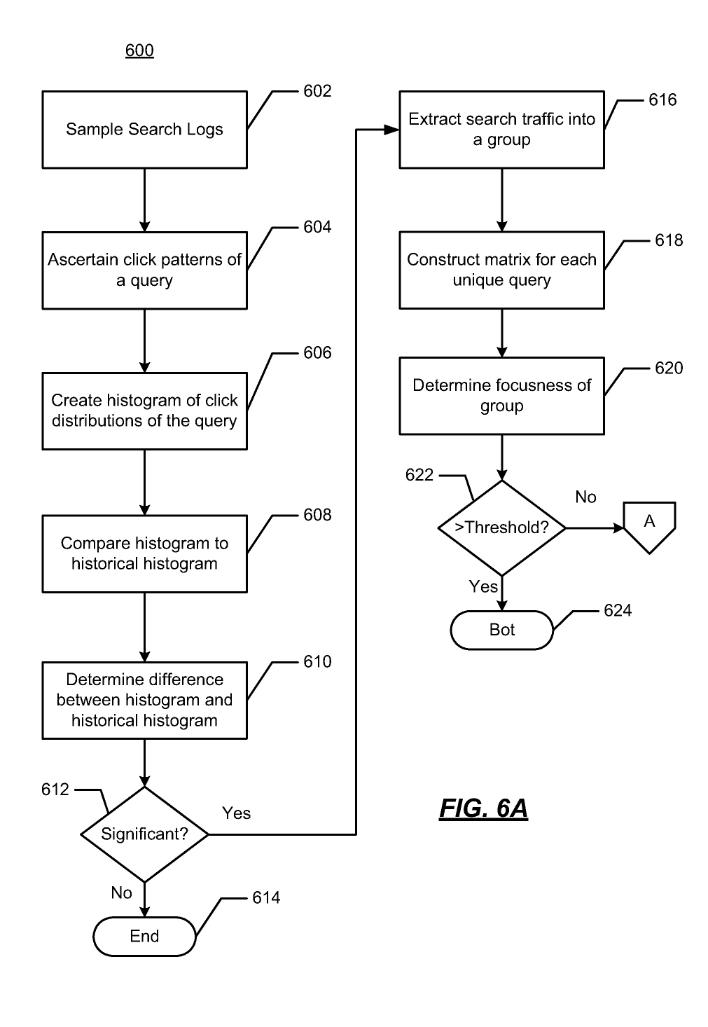

FIG. 5 shows a distribution of F_{qc} across all groups that are detected by the history-based scheme. As shown, more than 10% of groups have F_{qc} equal to zero. This shows that almost all users who perform these qc pairs conduct some other queries as well, suggesting that these groups to be flash crowd groups. There are a small fraction of groups with F_{qc} between 0.1 and 0.6. A majority (70%) of the groups have F_{qc}>0.7. For these groups, at least 70% of users conducted the qc pair query do not issue other queries. When F_{qc} is close to 1, it means almost all the users in the group search only the query q. Such users may be considered to be a very suspicious group, as normal users have diverse activities. As such, in some implementations, the framework 200 may set a threshold between 0.9 and 1 on F_{qc} for selecting bot groups.

The matrix-based bot detection engine 204 enables detection of groups with a dominant fraction of bot search traffic. However, the above is performed using a single fixed threshold based on the group “focusness” (F_{qc}) to reduce the number of false positives. If an attacker picks a more popular query by normal users, the fraction of bot traffic may not be large enough to meet this threshold, and hence the framework 200 may miss detecting the corresponding group. Furthermore, each bot user may submit multiple queries, and therefore appears to be normal.

In these cases, the framework 200 may include implementations to perform a principal component analysis (PCA) on those query matrices that do not meet the “focusness” threshold noted above. PCA is a statistical method to reduce data dimensionality without much loss of information. Given a set of high-dimensional data points, PCA finds a set of orthogonal vectors, called principal components that account for the variance of the input data. Dimensionality reduction may be achieved by projecting the original high-dimensional data onto the low-dimensional subspace spanned by leading orthogonal vectors.

Given a query matrix M_{qc}, it may be converted into a binary matrix B_{qc}, where B_{qc}(i,j)=1 if and only if M_{qc}(i,j)>0. PCA is then performed on the converted binary matrix. Because bot user queries are typically strongly correlated while normal user queries are not, the subspace defined by the largest principal component corresponds to the subspace of bot user queries, if they exist. As such, the framework 200 may select the largest principal component denoted as E₁ and then computes the percentage of data variance P₁ accounted for by E₁. A large P₁ means a large percentage of users all exhibited strong correlations in their query patterns and are thus suspicious. Although a one-dimensional subspace is described above, more than one principal component may be used. For example, the first two (or more) leading principal components may be used to form the subspace through the application of the method herein.

To further identify suspicious users, for any matrix B_{qc} with P₁ greater than a threshold (e.g., 60%), the column vectors that correspond to the subspace defined by E₁ are identified. To do so, B_{qc} is projected onto the subspace defined by E₁ to obtain a projected matrix B_{qc}. For each column (user) vector uᵢ in the original matrix B_{qc}, its corresponding vector in the projected matrix B_{qc} is denoted as u′ᵢ. If the L₂ norm difference between uᵢ and u′ᵢ is very small, that means the projection onto the subspace B_{qc} does not significantly change the vector uᵢ and, thus, the principal component E₁ describes the data well. Therefore, the framework 200 may select the k user vectors with the smallest L₂ norm differences ∥uᵢ−u′ᵢ∥ such that:

$$k = ⌊ m \times \frac{{‖ {E}_{1} ‖}_{2}}{{‖ E ‖}_{2}} ⌋$$

The corresponding k users are the suspicious users in a group as their query vectors change the least from the original space after projecting into the one-dimension subspace.

In some implementations, because the number of columns (users) m in a matrix can be very large, a predetermined number of users may be sampled (e.g., 1000) to construct a smaller sampled query matrix M_{qc}. The above computation may be performed on the sampled matrix. Correspondingly, the k selected suspicious users are only from the sampled matrix. In order to identify such similar suspicious users, the framework 200 may examine the query log and identify the users whose query-click pairs are identical to one of the selected k users from the sampled matrix. The remaining users are likely to be normal human users.

Table 1, below illustrates features of each pageview. As shown in Table 1, certain ones of the features may be used for detection of bots, whereas others may be used for validation. Various combinations of the features may be implemented for detection and/or validation.

TABLE 1

| | Features |
|---|---|
| For Detection | User ID (anonymized) |
| | Query Term |
| | Click |
| For Validation | Cookie (anonymized) |
| | Cookie creation time |
| | User agent (anonymized) |
| | Form |
| | Is JavaScript enabled |

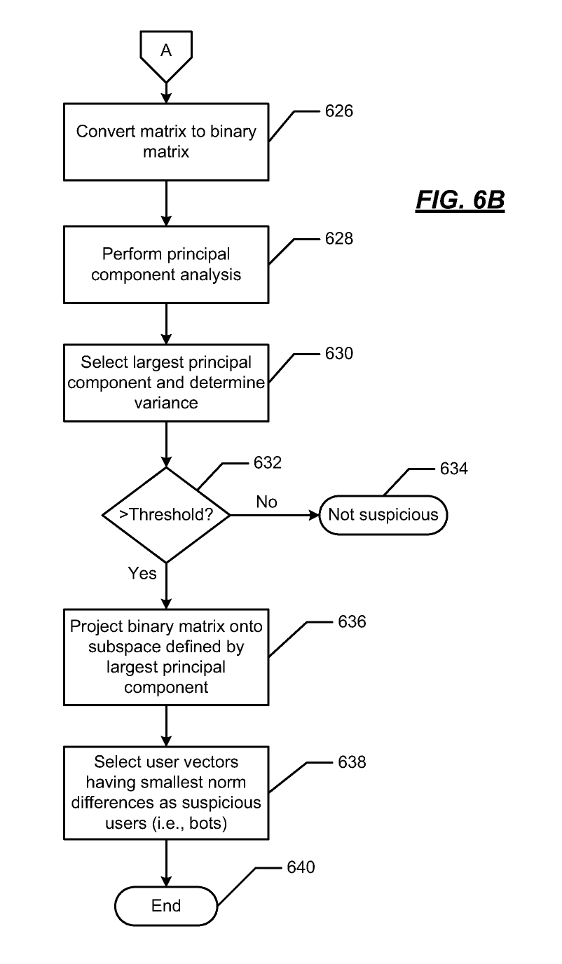

FIGS. 6A and 6B illustrate an exemplary process 600 for bot detection. The process of FIGS. 6A and 6B may be implemented in the framework 200 executing on one or more computing devices. At 602, search logs may be sampled. In accordance with implementations herein, sampled search logs or raw search logs may be input to the framework 200 for processing. The sampling may be performed by extracting data from the search logs based on the features noted above in Table 1, for example.

At 604, click patterns for a query are ascertained. Each query q submitted to the search engine 120 retrieves a query result page (e.g., page content 118) on which there may be one or more links. It may be determined if a particular user has clicked zero more of the links provided on the results page. At 606, a histogram of current click distributions is created. For example, a histogram such as shown in FIG. 4 may be created for the query q.

At 608, the histogram created at 606 is compared to the historical histogram for the query q. A smoothed Kullback-Leibler divergence may be used to compare the current histogram to the historical histogram. At 610, the difference between the current histogram and historical histogram is determined. The difference between the histograms may be determined as the result of the Kullback-Leibler divergence.

At 612, it is determined if the difference determined at 610 is significant. A significant difference indicates that the current histogram created at 606 may be representative of a suspicious query q. For example, the query q may be the result of bot events or flash crowd events. If the difference is not significant, then at 614 the process ends. However, if the difference is significant at 612, then the process continues at 616, where search traffic it extracted into a group. The group may be based on one or more of the features of the search traffic, as noted above. At 618, a matrix is constructed. Within the group, unique queries are identified in the rows of the matrix and each column represents a particular user who issued the queries identified in the rows.

At 620, the “focusness” of the group is determined. The “focusness” is a measure of the behavior (the queries issued) of the users within the group. As the “focusness” approaches one, it indicates that almost all users in the group searched a particular query q. At 622, it is determined if the “focusness” of the group exceeds a threshold. For example, the threshold may be set to a value between 0.9 and 1 in order to avoid false positives. If the “focusness” of the group is greater than the threshold, then at 624 it is determined that those users who issued the particular query q are bots.

If at 622, the “focusness” is less than the threshold, further analysis may be performed with regard to the users within the group to determine if the users in the group that submitted the query q represent bots or are part of a flash crowd event. Processing may continue at 626, where the matrix created at 618 is converted to a binary matrix, as described above. Once converted to a binary matrix, then at 628, principal component analysis (PCA) is performed. PCA reduces data dimensionality and finds a set of orthogonal vectors that account for variance of input data. At 630, a largest principal component is selected and a variance thereof determined. The largest principal component may be indicative of bot activity.

At 632, it is determined if the variance at 630 exceeds a threshold. If not, then the activity is determined to be not suspicious (i.e., not bot activity) at 634. If the variance does exceed the threshold at 632, then at 636, the binary matrix is projected onto subspace defined by largest principal component. Next, at 638, the user vectors having smallest norm differences are selected as suspicious users. Such suspicious users are likely bots that issued the query q. The process then ends at 640.

Thus, as described above, the framework 200 and process 600 for detecting bots may be used for spammer detection, Distributed Denial of Service (DDoS) prevention, click fraud detection, phishing site detection, bot-account detection and software patching.

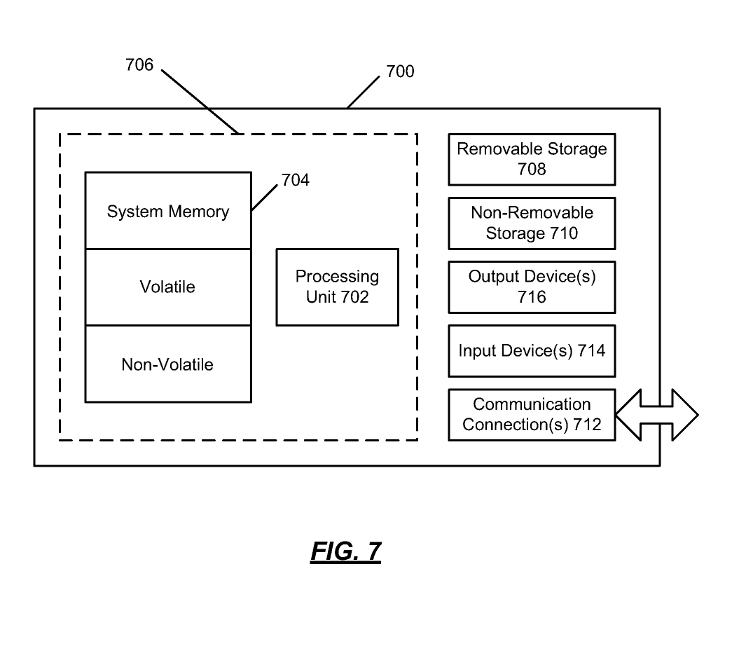

FIG. 7 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by device 700 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communications connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for identifying bots, comprising:
processing a search log maintained by a search engine to extract features of searches conducted by users that have submitted queries to the search engine;
performing a history-based anomaly detection by comparing click patterns associated with a query in the search log to historical click patterns associated with the query; and
performing a matrix-based bot detection using a matrix composed of a group of users, the matrix-based bot detection classifying users within the group as bots based on a correlation of queries within the set of queries submitted by the group of users to the search engine.

2. The method of claim 1, wherein performing the history-based anomaly detection further comprises determining a difference between the click patterns and the historical click patterns to identify suspicious query-click pairs.

3. The method of claim 2, wherein performing the matrix-based bot detection further comprises constructing the matrix in accordance with a predetermined feature of the group of users.

4. The method of claim 1, further comprising classifying the users as bots based on a percentage of traffic originating from the users with respect to the group of users that contains bots.

5. The method of claim 1, further comprising:
performing a principal component analysis of the group of users to determine correlations among the queries submitted by the group of users; and
classifying a subset of users as bots if the queries submitted by these users are correlated.

6. The method claim 5, further comprising:
converting the matrix to a binary matrix;
projecting the binary matrix onto a subspace defined by a largest principal component to determine a projected binary matrix;
determining a difference between a column vector in the binary matrix associated with a user within the group and a corresponding column vector in the projected binary matrix; and
classifying the user as a bot in accordance with the difference.

7. The method of claim 6, further comprising:
determining a percentage of data variance of the largest principal component; and
determining the column vector in the binary matrix if the percentage of data variance is greater than a first threshold.

8. The method of claim 1, further comprising sampling the search log.

9. The method of claim 1, wherein the features comprise at least one of a client identifier, query, clicks, hash of cookie, cookie data, Internet Protocol address, hash of user agent, form code, or whether JavaScript is enabled on a client.

10. The method of claim 1, further comprising classifying users within the group as bots if the correlation of queries within the set of queries is greater than a second threshold.

11. A system for identifying bots, comprising:
a history-based anomaly detection engine that compares click patterns associated with a query in a search log to historical click patterns associated with the query; and
a matrix-based bot detection engine that uses a matrix composed of a group of users, the matrix-based bot detection classifying users within the group as bots based on a correlation of queries within the set of queries submitted by the group of users to a search engine.

12. The system of claim 11, wherein the matrix-based bot detection engine further constructs the matrix in accordance with a predetermined feature of the group of users.

13. The system of claim 11, wherein the matrix-based bot detection engine further performs a principal component analysis of the group of users to determine correlations among the queries submitted by the group of users, and wherein the matrix-based bot detection engine classifies a subset of users as bots if the queries submitted by these users are correlated.

14. The system of claim 11, wherein the predetermine features comprises at least one of a client identifier, query, clicks, hash of cookie, cookie data, Internet Protocol address, hash of user agent, form code, or whether JavaScript is enabled on a client.

15. A method for identifying suspicious search-related traffic, comprising:
performing a history-based anomaly detection by comparing a histogram of links returned by a query versus a percentage of clicks associated with each link to a historical histogram of links returned by the query versus a historical percentage of clicks associated with each link to determine suspicious query-click pairs within a search log;
creating a matrix of a group of users that submitted the suspicious query-click pairs in accordance with a feature of the group of the users; and
performing a matrix-based bot detection using the matrix to classify users within the group of users as bots based on a correlation of queries within the suspicious query-click pairs submitted by the group of users to a search engine.

16. The method of claim 15, further comprising classifying the users as bots based on a percentage of traffic originating from the users with respect to the group of users that contain bots.

17. The method of claim 15, further comprising:
performing a principal component analysis of the group of users to determine correlations among the queries submitted by the group of users; and
classifying a subset of users as bots if the queries submitted by these users are correlated.

18. The method claim 15, further comprising separating the bots from flash crowd traffic.

19. The method of claim 15, wherein the feature comprises at least one of a client identifier, query, clicks, hash of cookie, cookie data, Internet Protocol address, hash of user agent, form code, or whether JavaScript is enabled on a client.

20. The method of claim 15, further comprising classifying users within the group as bots if the correlation of queries within the suspicious query-click pairs submitted by the users to the search engine is between 0.9 and 1.
